(19) United States
(12) Patent Application Publication
(10) Pub. No.: US 2011/0038331 A1
(43) Pub. Date: Feb. 17, 2011

(54) Control Channel Transmission With Component Carrier Aggregation

(75) Inventors: Mieszko Chmiel, Wroclaw (PL); Lars E. Lindh, Helsingfors (FI); Frank Frederiksen, Klarup (DK)

Correspondence Address: HARRINGTON & SMITH, 4 RESEARCH DRIVE, Suite 202, SHELTON, CT, 06484-6212, US

(73) Assignee: Nokia Siemens Networks Oy

(21) Appl. No.: 12/849,888

(22) Filed: Aug. 4, 2010

Related U.S. Application Data
(60) Provisional application No. 61/274,309, filed on Aug. 14, 2009.

(51) Int. Cl. H04W 4/00

(52) U.S. Cl. 370/329

(57) ABSTRACT

In accordance with the exemplary embodiments of the invention there is at least a method, apparatus, and computer program configured to compose signaling to include a component carrier indicator in a content of a downlink control information only when a size of an original part of a downlink control information on a scheduling component carrier is larger than or equal to an individual size of any corresponding downlink control information on at least one cross-scheduled component carrier, and to transmit the composed signaling to at least one user equipment.

### CROSS-REFERENCE TO RELATED APPLICATIONS

This patent application claims priority under 35 U.S.C. §119(e) from Provisional Patent Application No. 61/274, 309, filed Aug. 14, 2009, the disclosure of which is incorporated by reference herein in its entirety.

### TECHNICAL FIELD

The exemplary and non-limiting embodiments of this invention relate generally to wireless communication systems, methods, devices and computer programs and, more specifically, relate to control channel transmission and content in a case of component carrier aggregation.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3GPP third generation partnership project
BW bandwidth
CC component carrier
CC ID CC indicator
DCI downlink control information
DL downlink (eNB to UE)
eNB evolved Node B
E-UTRA evolved universal terrestrial radio access
LTE long term evolution
LTE-A LTE advanced
MCC mobile competence center
PDCCH physical downlink control channel
PDSCH physical downlink shared channel
RAN radio access network
Rel release
TR technical report
TS technical specification
TX transmit
UE user equipment
UL uplink (UE to eNB)

The specification of a communication system known as evolved UTRAN (EUTRAN, also referred to as UTRAN-LTE or as E-UTRA) is currently nearing completion within the 3GPP. As specified the DL access technique is OFDMA, and the UL access technique is SC-FDMA.

One specification of interest is 3GPP TS 36.300, V8.8.0 (2009-04), 3rd Generation Partnership Project; Technical Specification Group Radio Access Network; Evolved Universal Terrestrial Radio Access (EUTRA) and Evolved Universal Terrestrial Access Network (EUTRAN); Overall description; Stage 2 (Release 8), incorporated by reference herein in its entirety.

FIG. 1 reproduces FIG. 4.1 of 3GPP TS 36.300, and shows the overall architecture of the EUTRAN system (Rel-8). The EUTRAN system includes eNBs, providing the E-UTRA user plane and control plane (radio resource control) protocol terminations towards the UE. The eNBs are interconnected with each other by means of an X2 interface. The eNBs are also connected by means of an S1 interface to an evolved packet core (EPC), more specifically to a mobile management entity (MME) by means of a S1 MME interface and to a serving gateway (SGW) by means of a S1 interface. The S1 interface supports a many to many relationship between MMEs/Serving Gateways and eNBs.

The eNB hosts the following functions:

functions for Radio Resource Management: Radio Bearer Control, Radio Admission Control, Connection Mobility Control, Dynamic allocation of resources to UEs in both uplink and downlink (scheduling);
IP header compression and encryption of the user data stream;
selection of a MME at UE attachment;
routing of User Plane data towards Serving Gateway;
scheduling and transmission of paging messages (originated from the MME);
scheduling and transmission of broadcast information (originated from the MME or O&M (operation and maintenance)); and
measurement and measurement reporting configurations to provide mobility and scheduling.

Of particular interest herein are the further releases of 3GPP LTE (e.g., LTE Rel-10) targeted towards future IMT-A systems, referred to herein for convenience simply as LTE-Advanced (LTE-A). Reference in this regard may be made to 3GPP TR 36.913, V8.0.1 (2009-03), 3rd Generation Partnership Project; Technical Specification Group Radio Access Network; Requirements for Further Advancements for E-UTRA (LTE-Advanced) (Release 8), incorporated by reference herein in its entirety.

Component carrier aggregation is proposed to be included in LTE-Advanced. This technique, as a bandwidth extension, can provide significant gains in terms of peak data rate and cell throughput as compared to non-aggregated operation as in LTE Rel 8.

In RAN1 #56bis (R1-092199, “Final Report of 3GPP TSG RAN WG1 #56bis v2.0.0 (Seoul, South Korea, 23-27 March, 2009)”, MCC Support, it was agreed that a PDCCH is sent within one component carrier. Left for future study (FFS) were the mapping/coding of PDCCH information related to PDSCH from each CC. This could imply a separate PDCCH for each CC, where one PDCCH indicates the same CC, one PDCCH indicates the same or different CC, and an overhead increase corresponds to the number of CCs. Alternatively, there could be a common PDCCH (e.g., jointly coded) on one CC, and the PDCCH indicates multiple CCs.

In RAN1 #57, “Draft Report of 3GPP TSG RAN WG1 #57 v0.3.0 (San Francisco, USA, 4-8 May, 2009)”, MCC Support, the above referenced FFS items, based on the motivation in R1-091743, “PDCCH design for carrier aggregation”, Panasonic and R1-091966, “Anchor component carrier”, Fujitsu, were further narrowed down. More specifically, it was decided to use separate coding of DL assignments and UL grants for each component carrier based on DCI format(s) for single carrier, with an additional carrier indicator field of 0-3 bits. In a case of 0 bits, no carrier indicator is used.

According to 3GPP TS 36.212, “Evolved Universal Terrestrial Radio Access (E-UTRA); Multiplexing and channel coding” (Release 8) V2.0.0 (2007-09) the size of a given control channel (downlink control information—DCI) is not always constant but depends on various factors such as the BW of the cell and the number of TX antennas configured in the cell. Furthermore, in 3GPP TR 36.814, v0.4.1, “Further Advancements for E-UTRA Physical Layer Aspects” (Release 9) it is mentioned that “it will be possible to configure a UE to aggregate a different number of component carriers of possibly different bandwidths in the UL and the DL”. In R4-091674, “TP for LTE-Advanced deployment scenarios”, Nokia Siemens Networks there is a discussion of scenarios with a cell containing aggregated component carriers of different BWs (e.g., #7 and #10 in section 5.1.2).

### SUMMARY

In an exemplary aspect of the invention, there is a method, comprising composing signaling to include a component carrier indicator in a content of a downlink control information only when a size of an original part of a downlink control information on a scheduling component carrier is larger than or equal to an individual size of any corresponding downlink control information on at least one cross-scheduled component carrier, and transmitting the composed signaling to at least one user equipment.

In another exemplary aspect of the invention, there is an apparatus comprising at least one processor, and at least one memory including computer program code, where the at least one memory and the computer program code are configured, with the at least one processor, to cause the apparatus to at least compose signaling to include a component carrier indicator in a content of a downlink control information only when a size of an original part of a downlink control information on a scheduling component carrier is larger than or equal to an individual size of any corresponding downlink control information on at least one cross-scheduled component carrier, and transmit the composed signaling to at least one user equipment

In yet another exemplary aspect of the invention, there is an apparatus comprising means for composing signaling to include a component carrier indicator in a content of a downlink control information only when a size of an original part of a downlink control information on a scheduling component carrier is larger than or equal to an individual size of any corresponding downlink control information on at least one cross-scheduled component carrier, and means for transmitting the composed signaling to at least one user equipment.

In accordance with the apparatus described above, the means for composing signaling and means for transmitting the composed signaling comprises a transmitter, electronic circuitry, and a computer readable memory embodying computer program code executed by at least one processor.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 reproduces FIG. 4.1 of 3 GPP TS 36.300, and shows the overall architecture of the EUTRAN system.

FIG. 2 shows a simplified block diagram of various electronic devices that are suitable for use in practicing the exemplary embodiments of this invention.

FIG. 3 illustrates an exemplary case where the DCI size of CC 0 is larger than that of CC 1 and, thus, a DCI with a CC index can be used.

FIG. 4 illustrates an exemplary case where the size of the DCI of CC 0 is smaller than that of CC 1 and, thus, a DCI with a CC index cannot be used.

FIGS. 5 and 6 shows Tables 1 and 2, respectively, where Table 1 shows a non-limiting example of no change to DCI format types, while Table 2 shows a non-limiting example of a change in DCI format types depending on the CC indicator.

FIG. 7 shows a Table 3 which is a non-limiting example of a configuration where the CC indicator remains constant for all scheduled component carriers.

FIG. 8 is a logic flow diagram that illustrates the operation of a method, and a result of execution of computer program instructions embodied on a computer readable memory, in accordance with the exemplary embodiments of this invention.

FIG. 9 is a logic flow diagram that illustrates the operation of a method, and a result of execution of computer program instructions embodied on a computer readable memory, further in accordance with the exemplary embodiments of this invention.

### DETAILED DESCRIPTION

The exemplary embodiments of this invention address and solve certain problems related to the control channel design in support of component carrier aggregation.

Based on the above-described LTE-A agreements and observations at least one problem is apparent: i.e., the UL/DL assignments with a carrier indicator are based on a DCI of a single carrier, while a DCI of one type for different component carriers may have different sizes due to, for example, different BWs of the addressed CCs.

At first glance one might propose to use one of the following solutions to this problem.

For example, one may allow cross-component carrier scheduling (i.e., include a carrier indicator in the DCI format) only when the BWs of the aggregated carriers (and other parameters determining the size of a DCI format such as the number of TX antennas) are the same across aggregated component carriers. Otherwise, the cross-component carrier scheduling is not possible (i.e., the carrier indicator is not present in the DCI format).

It should be noted that this approach may not be optimum in that cross-component carrier scheduling is only available when the parameters of the aggregated carriers are the same. However, one may consider the cross-CC scheduling as a viable method to mitigate the coverage issues of control channels in low BWs, when the PDSCH of a carrier with a low BW can be scheduled from a CC with a wider BW, and obtain a better control channel coverage.

Another possible solution would be to only allow component carrier aggregation when the BWs (and other parameters determining the size of a DCI format) of the aggregated carriers are the same.

However, a potential disadvantage of this approach is that it would not be in-line with the assumptions in RAN1 and RAN4 LTE-A, and may be seen as being overly restrictive from an LTE-A deployment perspective.

Another possible solution would be to define the DCI format with a CC indicator according to the worst case size of a single carrier DCI.

However, at least one perceived drawback to this approach would be an increase in the overhead and, thus, reduced coverage of the control channel.

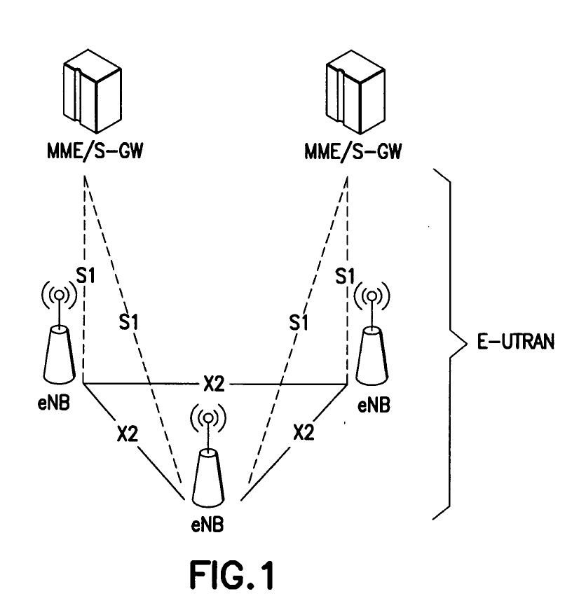

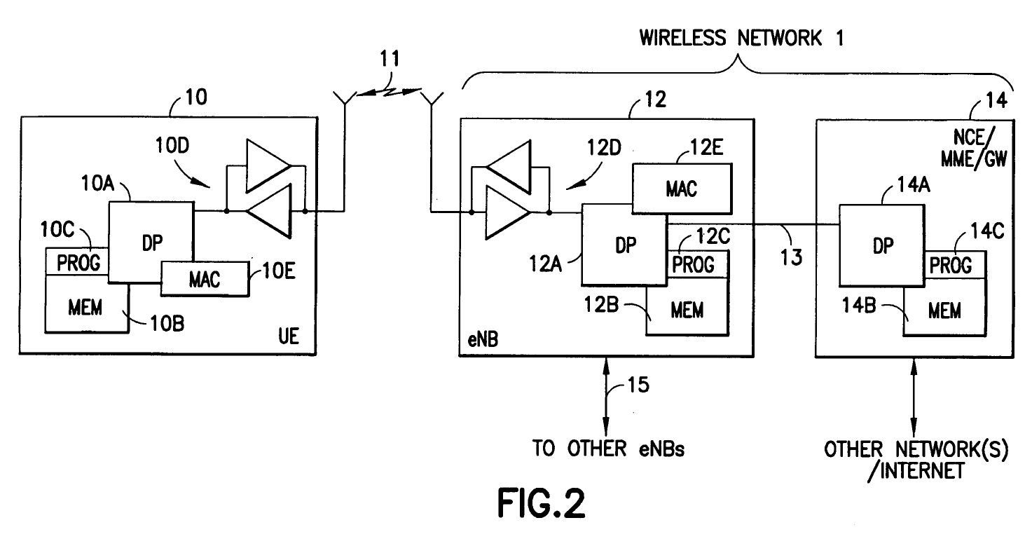

Before describing in detail the exemplary embodiments of this invention, reference is made to FIG. 2 for illustrating a simplified block diagram of various electronic devices and apparatus that are suitable for use in practicing the exemplary embodiments of this invention. In FIG. 2 a wireless network 1 is adapted for communication over a wireless link 11 with an apparatus, such as a mobile communication device which may be referred to as a UE 10, via a network access node, such as a Node B (base station), and more specifically an eNB 12. The network 1 may include a network control element (NCE) 14 that may include the MME/SGW functionality shown in FIG. 1, and which provides connectivity with a further network, such as a telephone network and/or a data communications network (e.g., the interne). The UE 10 includes a controller, such as a computer or a data processor (DP) 10A, a computer-readable memory medium embodied as a memory (MEM) 10B that stores a program of computer instructions (PROG) 10C, and a suitable radio frequency (RF) transmitter and receiver 10D for bidirectional wireless communications with the eNB 12 via one or more antennas. The eNB 12 also includes a controller, such as a computer or a data processor (DP) 12A, a computer-readable memory medium embodied as a memory (MEM) 12B that stores a program of computer instructions (PROG) 12C, and a suitable RF transmitter and receiver 12D for communication with the UE 10 via one or more antennas. The eNB 12 is coupled via a data/control path 13 to the NCE 14. The path 13 may be implemented as the S1 interface shown in FIG. 1. The eNB 12 may also be coupled to another eNB via data/control path 15, which may be implemented as the X2 interface shown in FIG. 1.

For the purposes of describing the exemplary embodiments of this invention the UE 10 may be assumed to also include a medium access control (MAC) unit 10E that receives and interprets DL control channel signaling in accordance with the exemplary embodiments of this invention, and the eNB 12 also includes a MAC unit 12E that composes DL control channel signaling in accordance with the exemplary embodiments of this invention.

At least one of the PROGs 10C and 12C is assumed to include program instructions that, when executed by the associated DP, enable the device to operate in accordance with the exemplary embodiments of this invention, as will be discussed below in greater detail. That is, the exemplary embodiments of this invention may be implemented at least in part by computer software executable by the DP 10A of the UE 10 and/or by the DP 12A of the eNB 12, or by hardware, or by a combination of software and hardware (and firmware).

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 10B and 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on a multi-core processor architecture, as non-limiting examples.

In accordance with the exemplary embodiments of this invention the problems discussed above are solved by allowing the eNB 12 to include the component carrier indicator in the content of a DCI only when the following condition is fulfilled:

the size of the original part of the DCI (corresponding to the DCI size without CC indicator) on the scheduling CC is larger than or equal to the individual size(s) of the corresponding DCI(s) on the cross-scheduled CCs.

In this approach the CC indicator can consider/address those CCs whose DCI sizes are equal to or smaller than the corresponding DCI size of the carrier transmitting the DCI with the CC indicator.

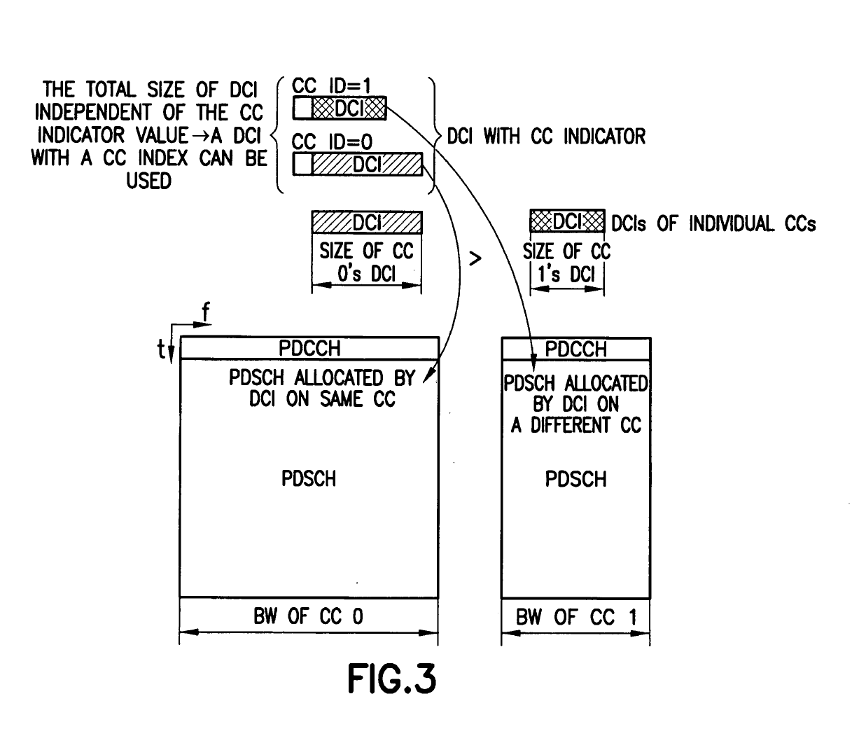

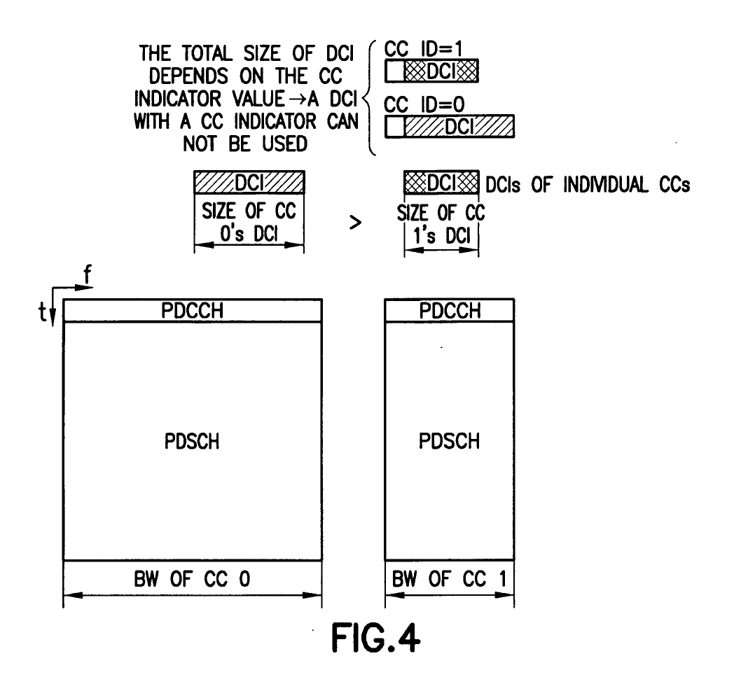

This principle is illustrated in FIG. 3, where the DCI size of CC 0 is larger than that of CC 1 and, thus, a DCI with a CC index can be used. In the example of FIG. 4 it is shown that the size of the DCI of CC 0 is smaller than that of CC 1 and, thus, a DCI with a CC index cannot be used. In both FIGS. 3 and 4 the axes designated t and f are time and frequency, respectively.

In an alternative exemplary embodiment, the CC indicator can also consider/address those CCs whose DCI sizes are larger than the corresponding DCI size of the carrier transmitting the DCI with the CC indicator.

In some embodiments it is allowable for the DCI in CC1 to include CC indicators as well as a DCI for CC0, even though the DCI in this non-limiting example would not be able to assign resources with full resolution. In this case, the allocated resources on CC0 may be signaled with either reduced bandwidth (such that only the bandwidth of CC1 can be scheduled), or the resolution of the signaling may be decreased such that the full bandwidth can be indicated. Either approach for remapping resources on CC1 to CC0 using the DCI format of CC1 can be readily implemented by minor expansions of the signaling.

What may be considered as a relaxation of the rule or condition above (to allow for enhanced PDCCH flexibility) is as follows:

if (N_DL1>=N_DL2), PDCCH_CC1 can address CC1 as well as CC2, PDCCH_CC2 can address CC2 with full signaling resolution, while CC1 can be addressed with limited resolution. In this formulation N_DL1 and N_DL2 denote the BW for CC1 and CC2, respectively.

For example, if CC1 is 20 MHz, and CC2 is 10 MHz, a CC1 being addressed by PDCCH_CC2 would have an “addressing space” corresponding (only) to the first 10 MHz. Alternatively, resolution scaling factors may be introduced to increase the maximum scheduling bandwidth to the full 20 MHz.

In principle, each UE 10 is configured in a certain transmission mode to monitor some number of DCI format sizes, limited by a blind decoding budget. Therefore, the UE 10 knows the DCI sizes that it should monitor in each component carrier. The UE 10 also knows its configuration of component carrier aggregation. Based on this information the UE 10 determines which CCs in the aggregation can include DCI formats with a CC indicator, and the scope of the CC indicator transmitted on each CC.

It should be noted as well that there may be an additional signaling parameter that may be used to enable or disable CC indicator usage/inclusion per an entire CC aggregation, or per CC. There may also be a signaled parameter which includes/excludes each CC individually from the possibility to be addressed by a CC indicator. These signaled parameter(s), if used, may be semi-static RRC signaling parameters.

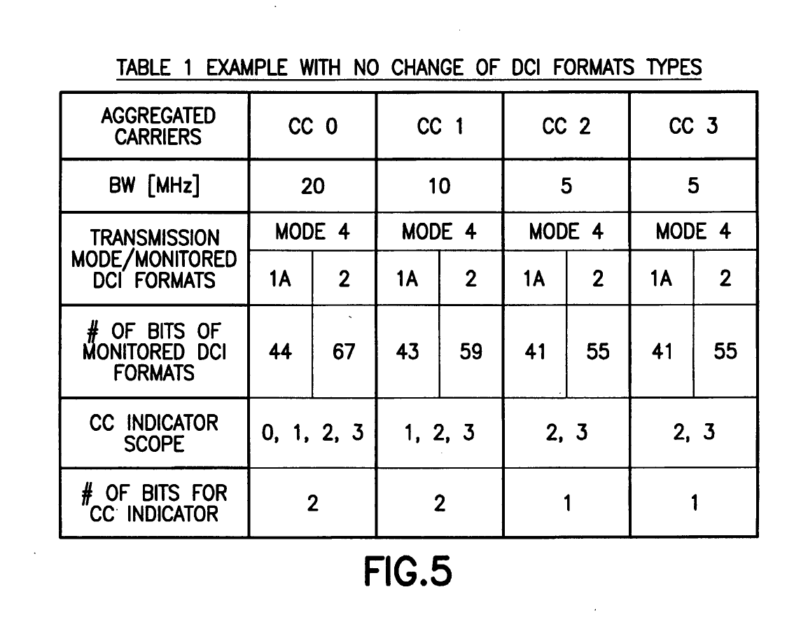

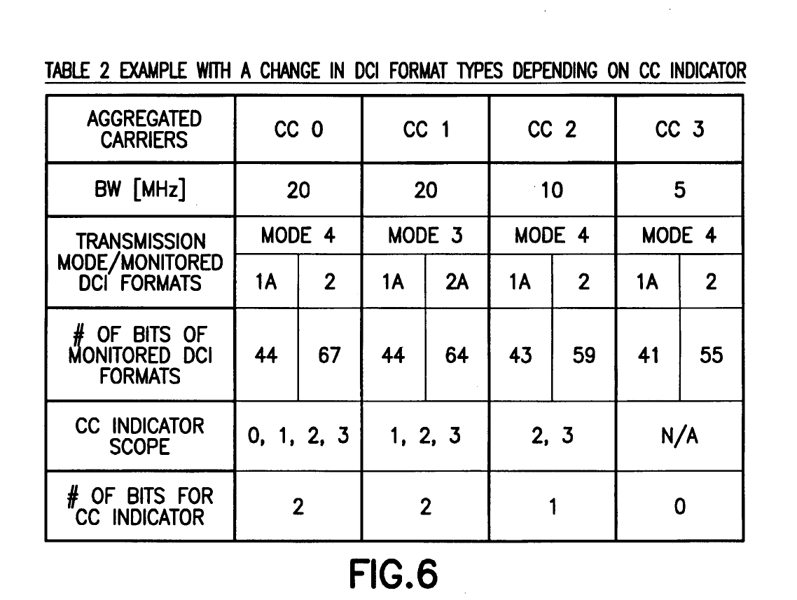

The Tables 1 and 2 shown in FIGS. 5 and 6, respectively, provide non-limiting examples illustrating the exemplary embodiments of this invention, based on the DCI formats and BWs specified in LTE Rel-8. Table 1 shows a non-limiting example with no change to DCI format types, while Table 2 shows a non-limiting example of a change in DCI format types depending on the CC indicator. FIG. 7 shows a Table 3 which is a non-limiting example of a configuration where the CC indicator remains constant for all scheduled component carriers.

With reference to Tables 1, 2 and 3, transmission modes are described in 3GPP TS 36.213, V8.7.0 (2009-05) Technical Specification 3rd Generation Partnership Project; Technical Specification Group Radio Access Network; Evolved Universal Terrestrial Radio Access (E-UTRA); Physical layer procedures Release 8), such as in subclause 7.1. DCI formats are described in 3GPP TS 36.212 and the BWs are specified in 3GPP TS 36.101 V8.6.0 (2009-06) Technical Specification 3rd Generation Partnership Project; Technical Specification Group Radio Access Network; Evolved Universal Terrestrial Radio Access (E-UTRA); User Equipment (UE) radio transmission and reception (Release 8), such as in subclause 5 “Operating bands and channel arrangement”. In general, the Tables show an exemplary CC aggregation and how the foregoing rules for the CC indicator scope and usage would apply and operate.

It can be noted that the use of the CC indicator typically should not change the DCI type when scheduling the PDSCH on another carrier (see the example in Table 1). However, the exemplary embodiments of this invention are not limited to such a case. In general, so long as the size condition is fulfilled, and the UE 10 knows which DCI format to decode in relation to which carrier, the DCI format type can change depending on the CC indicator value. This is shown in the example in Table 2, where the CC indicator on CC 0 indicates an allocation on CC 1, and DCI 2 changes to DCI 2A. This may be viewed in some cases as an example of dynamically changing the transmission mode.

For a case where there are one or more spare bits due to cross-component carrier scheduling in a DCI format with a CC indicator (as shown in FIG. 3), the spare bits may be used to provide additional protection of the DCI, e.g., by repetition coding some portion of the DCI content.

It should be noted that while the examples given above have assumed DL PDCCH assignment and DL data transmission on the PDSCH, the exemplary embodiments of this invention apply equally to UL PDCCH assignment and UL data transmission on the PUSCH.

In addition, it should be noted that in accordance with the exemplary embodiments of the invention there can be an additional semi-static signaling parameter which would enable or disable CC indicator usage and/or inclusion per a whole aggregation or per a component carrier. Further, in accordance with the exemplary embodiments the DCI format type can change depending on a CC indicator value. In addition, it is noted that a use of a CC indicator is not limited to the DCI formats of the same type. Additionally, in accordance with the exemplary embodiments the cross-component carrier scheduling can be utilized to address CCs of different bandwidths.

There are a number of advantages and technical effects that can be realized by the use of the exemplary embodiments of this invention. For example, the use of the CC indicator is not limited to carrier aggregations with the same DCI sizes, and is not limited to DCI formats of the same type. Further, the scope of the CC indicator does not have to be the same on each aggregated CC. In addition, the total DCI size does not depend on the CC indicator value and, thus, there is no increase in the blind decoding budget of the UE 10. A still further advantage and technical effect that can be realized by the use of the exemplary embodiments of this invention is that cross-component carrier scheduling can be utilized to address CCs of different bandwidths and, thus, the control channel coverage limitations of low BW CCs may be overcome.

Based on the foregoing it should be apparent that the exemplary embodiments of this invention provide a method, apparatus and computer program(s) to indicate a carrier indicator in the content of a downlink control information only when the following condition is fulfilled: a size of an original part of the downlink control information, implied by an individual downlink control information size of a particular carrier with no component carrier indicator, is greater than or equal to the individual size(s) of any corresponding downlink control information that is implied by the configuration of other carrier(s) scheduled by the downlink control information with the component carrier indicator.

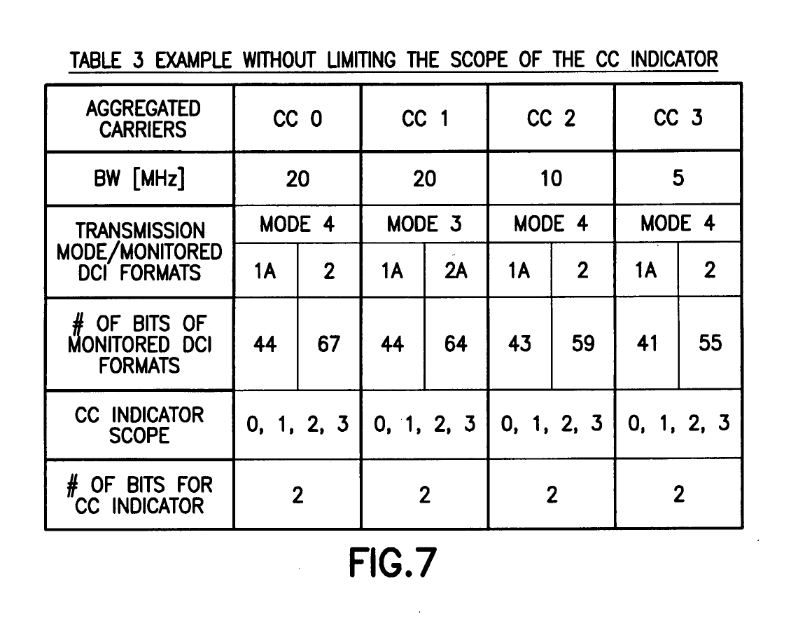

FIG. 8 is a logic flow diagram that illustrates the operation of a method, and a result of execution of computer program instructions, in accordance with the exemplary embodiments of this invention. In accordance with these exemplary embodiments a method performs, at Block 8A, a step of composing signaling to include a component carrier indicator in the content of a downlink control information only when a size of an original part of the downlink control information (corresponding to the downlink control information size without the component carrier indicator) on a scheduling component carrier is larger than or equal to the individual size(s) of any corresponding downlink control information on a cross-scheduled component carrier or carriers. At Block 8B there is a step of transmitting the composed signaling to at least one user equipment.

In the method of FIG. 8, the component carrier indicator is descriptive of those component carriers whose DCI sizes are equal to or smaller than the corresponding downlink control information size of the carrier transmitting the downlink control information with the component carrier indicator.

In the method of FIG. 8, further comprising sending an additional signaling parameter to enable or disable component carrier indicator usage/inclusion per an entire component carrier aggregation.

In the method of FIG. 8, further comprising sending an additional signaling parameter to enable or disable component carrier indicator usage/inclusion per individual component carrier.

In the method of FIG. 8, further comprising sending an additional signaling parameter to include/exclude each component carrier individually as being addressed by a component carrier indicator.

In the method of FIG. 8, where inclusion of the component carrier indicator does not change the downlink control information format type.

In the method of FIG. 8, where inclusion of the component carrier indicator changes the downlink control information format type.

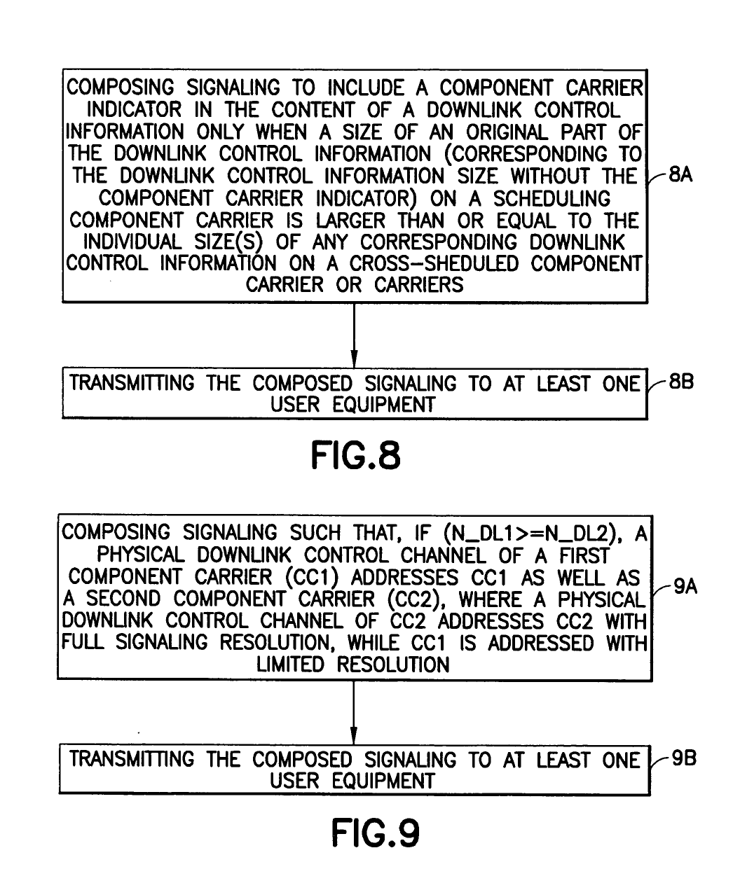

FIG. 9 is a logic flow diagram that illustrates the operation of a method, and a result of execution of computer program instructions, further in accordance with the exemplary embodiments of this invention for a case where a low bandwidth CC is configured to schedule a high bandwidth CC with limited resolution. At Block 9A there is a step of composing signaling such that, if (N_DL1>=N_DL2), a physical downlink control channel of a first component carrier (CC1) addresses CC1 as well as a second component carrier (CC2), where a physical downlink control channel of CC2 addresses CC2 with full signaling resolution, while CC1 is addressed with limited resolution. At Block 9B there is a step of transmitting the composed signaling to at least one user equipment.

The various blocks shown in FIGS. 8 and 9 may be viewed as method steps, and/or as operations that result from operation of computer program code, and/or as a plurality of coupled logic circuit elements constructed to carry out the associated function(s).

In accordance with an exemplary aspect of the invention there is at least a method, apparatus, and executable computer program to perform actions including composing signaling to include a component carrier indicator in a content of a downlink control information only when a size of an original part of a downlink control information on a scheduling component carrier is larger than or equal to an individual size of any corresponding downlink control information on at least one cross-scheduled component carrier and transmitting the composed signaling to at least one user equipment.

Further, in accordance with the paragraph above the size of the original part of the downlink control information corresponds to the downlink control information size without a component carrier indicator.

In addition, in accordance with any of the above paragraphs the component carrier indicator may be descriptive of those component carriers whose downlink control information sizes are equal to or smaller than a corresponding downlink control information size of a carrier transmitting the downlink control information with the component carrier indicator.

Further, in accordance with the paragraphs above there can be included sending an additional signaling parameter to enable or disable at least one of component carrier indicator usage and inclusion per an entire component carrier aggregation.

Additionally, in accordance with the paragraphs above there can be included sending an additional signaling parameter to enable or disable at least one of component carrier indicator usage and inclusion per individual component carrier.

Furthermore, in accordance with the paragraphs above there can be included sending an additional signaling parameter to one of include or exclude each component carrier individually as being addressed by a component carrier indicator.

Further, in accordance with the paragraph above an inclusion of a component carrier indicator does not change the downlink control information format type.

In accordance with at least the two previous the paragraphs an inclusion of a component carrier indicator changes the downlink control information format type.

Furthermore, in accordance with the paragraphs above there can be included that the signaling is composed such that, if the size of the original part of a downlink control information is larger than or equal to the individual size of the corresponding downlink control information, a physical downlink control channel of a first component carrier addresses the first component carrier and a second component carrier, where a physical downlink control channel of the second component carrier addresses the second component carrier with a full signaling resolution, while the first component carrier is addressed with limited resolution.

The exemplary embodiments of this invention also pertain to an apparatus comprising a processor and a memory that includes computer program code. The memory and the computer program code are configured to, with the processor, cause the apparatus to perform: compose signaling to include a component carrier indicator in the content of a downlink control information only when a size of an original part of the downlink control information, implied by an individual downlink control information size of a particular carrier with no component carrier indicator, is greater than or equal to the individual size(s) of any corresponding downlink control information that is implied by the configuration of other component carrier(s) scheduled by the downlink control information with the component carrier indicator; and transmit the composed signaling to at least one user equipment.

The apparatus as in the preceding paragraph, embodied in a base station, such as an enhanced Node B.

The exemplary embodiments of this invention also pertain to an apparatus comprising a processor and a memory that includes computer program code. The memory and the computer program code are configured to, with the processor, cause the apparatus to perform: compose signaling such that, if (N_DL1>=N_DL2), a physical downlink control channel of a first component carrier (CC1) addresses CC1 as well as a second component carrier (CC2), where a physical downlink control channel of CC2 addresses CC2 with full signaling resolution, while CC1 is addressed with limited resolution, and to transmit the composed signaling to at least one user equipment.

The apparatus as in the preceding paragraph, embodied in a base station, such as an enhanced Node B.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the UTRAN-LTE (Rel-8) and LTE-A systems, it should be appreciated that the exemplary embodiments of this invention are not limited for use with only these particular types of wireless communication system and/or releases thereof, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names assigned to different channels (e.g., PDCCH, PDSCH) and elements thereof (e.g., DCI, CC ID) are not intended to be limiting in any respect, as these various channels and elements may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method, comprising:
composing signaling to include a component carrier indicator in a content of a downlink control information only when a size of an original part of a downlink control information on a scheduling component carrier is larger than or equal to an individual size of any corresponding downlink control information on at least one cross-scheduled component carrier; and
transmitting the composed signaling to at least one user equipment.

2. The method according to claim 1, where the size of the original part of the downlink control information corresponds to the downlink control information size without a component carrier indicator.

3. The method according to claim 1, where the component carrier indicator is descriptive of those component carriers whose downlink control information sizes are equal to or smaller than a corresponding downlink control information size of a carrier transmitting the downlink control information with the component carrier indicator.

4. The method according to claim 1, further comprising:
sending an additional signaling parameter to enable or disable at least one of component carrier indicator usage and inclusion per an entire component carrier aggregation.

5. The method according to claim 1, further comprising:
sending an additional signaling parameter to enable or disable at least one of component carrier indicator usage and inclusion per individual component carrier.

6. The method according to claim 1, further comprising:
sending an additional signaling parameter to one of include or exclude each component carrier individually as being addressed by a component carrier indicator.

7. The method according to claim 6, where an inclusion of a component carrier indicator does not change the downlink control information format type.

8. The method according to claim 6, where an inclusion of a component carrier indicator changes the downlink control information format type.

9. The method according to claim 1, where the signaling is composed such that, if the size of the original part of a downlink control information is larger than or equal to the individual size of the corresponding downlink control information, a physical downlink control channel of a first component carrier addresses the first component carrier and a second component carrier, where a physical downlink control channel of the second component carrier addresses the second component carrier with a full signaling resolution, while the first component carrier is addressed with limited resolution.

10. The method according to claim 1 performed by a computer program code embodied on a tangible computer readable medium and executed by at least one processor.

11. An apparatus comprising:
at least one processor; and
at least one memory including computer program code, where the at least one memory and the computer program code are configured, with the at least one processor, to cause the apparatus to at least:
compose signaling to include a component carrier indicator in a content of a downlink control information only when a size of an original part of a downlink control information on a scheduling component carrier is larger than or equal to an individual size of any corresponding downlink control information on at least one cross-scheduled component carrier; and
transmit the composed signaling to at least one user equipment.

12. The apparatus according to claim 11, where the size of the original part of the downlink control information corresponds to the downlink control information size without a component carrier indicator.

13. The apparatus according to claim 11, where the component carrier indicator is descriptive of those component carriers whose downlink control information sizes are equal to or smaller than a corresponding downlink control information size of a carrier transmitting the downlink control information with the component carrier indicator.

14. The apparatus according to claim 11, further comprising:
the computer program code is configured, with the at least one processor, to cause the apparatus to send an additional signaling parameter to enable or disable at least one of component carrier indicator usage and inclusion per an entire component carrier aggregation.

15. The apparatus according to claim 11, further comprising:
the computer program code is configured, with the at least one processor, to cause the apparatus to send an additional signaling parameter to enable or disable at least one of component carrier indicator usage and inclusion per individual component carrier.

16. The apparatus according to claim 11, further comprising:
the computer program code is configured, with the at least one processor, to cause the apparatus to send an additional signaling parameter to one of include or exclude each component carrier individually as being addressed by a component carrier indicator.

17. The apparatus according to claim 16, where an inclusion of a component carrier indicator does not change the downlink control information format type.

18. The apparatus according to claim 16, where an inclusion of a component carrier indicator changes the downlink control information format type.

19. The apparatus according to claim 11, where the signaling is composed such that, if the size of the original part of a downlink control information is larger than or equal to the individual size of the corresponding downlink control information, a physical downlink control channel of a first component carrier addresses the first component carrier and a second component carrier, where a physical downlink control channel of the second component carrier addresses the second component carrier with a full signaling resolution, while the first component carrier is addressed with limited resolution

20. An apparatus comprising:
means for composing signaling to include a component carrier indicator in a content of a downlink control information only when a size of an original part of a downlink control information on a scheduling component carrier is larger than or equal to an individual size of any corresponding downlink control information on at least one cross-scheduled component carrier; and
means for transmitting the composed signaling to at least one user equipment.
